(19) United States
(12) Patent Application Publication
(10) Pub. No.: US 2002/0101351 A1
(43) Pub. Date: Aug. 1, 2002

(54) Remote child locator alarm

(76) Inventor: Joseph P. Lochner, Sullivan, MO (US)

Correspondence Address: B.Trent Webb, SHOOK, HARDY& BACON L.L.P., 1200 Main Street, Kansas City, MO, 64105-2118, US

(21) Appl. No.: 09/993,144

(22) Filed: Nov. 6, 2001

Related U.S. Application Data
(60) Provisional application No. 60/265,066, filed on Jan. 30, 2001.

(51) Int. Cl. G08B 23/00

(52) U.S. Cl. 340/573.1; 340/540

(57) ABSTRACT

A remote child locator alarm incorporating a remote unit and an alarm unit is disclosed. The remote unit preferably is a small size capable of being carried in the pocket of the parent of the child. The remote unit communicates wirelessly to the alarm unit, preferably via infrared means. The alarm unit is a relatively small device capable of being attached to the child's garments or person. The remote unit is equipped with means for communicating with the alarm unit to initiate an alarm sequence which emits a loud audible sound or words upon initiation of the sequence by the remote unit. In addition, the remote unit and alarm unit may be equipped with a proximity alarm which will allow the alarm and/or the remote unit to emit the loud sound or words when the alarm unit is transported beyond a predetermined distance from the remote unit.

### CROSS-REFERENCE TO RELATED APPLICATION

Pursuant to 35 U.S.C. Section 119(e), this application claims the benefit of copending U.S. provisional application Serial No. 60/265,066, filed Jan. 30, 2001, entitled “Remote Child Locator Alarm”, the entirety of the disclosure of which is hereby specifically incorporated by reference.

### FIELD OF THE INVENTION

This invention relates to child safety products and, more particularly, to a remote child locator alarm which can be manually initiated or initiated by proximity detector.

### BACKGROUND OF THE INVENTION

Unfortunately, every parent eventually will experience the nightmare of having lost their child. Whether at a crowded mall, in a park or even at home, occasionally children wander away and cannot be located by their parents. The moment a parent realizes their child is lost, they are overcome with panic, fear and dread. At that instant, every parent would pay any price for a mechanism that would allow them to locate their child immediately.

Worse yet, the reality of raising children in our society is that there is a real risk of child abduction. Being unable to locate a child in a crowded mall is a horrible experience, but that experience pales in comparison to realizing the possibility that your child has been abducted by another person. The thought of an abduction immediately comes to the minds of parents when they have lost their child and, regrettably, the fear of abduction is not entirely unjustified. The risk of abduction makes the parent of a lost child even more desireous of device that would enable them to not only locate their child, but to notify those persons near the child that he or she is lost. Such a notification hopefully would deter would-be abductors and would allow those persons in the vicinity of the child to intervene.

In the prior art there are devices harnessing children to their parents. Whether a wrist-located tether or a chest mounted harness is used, these devices all employ some physical means to retain the child within a predetermined distance to their parents. Often these devices are coupled with retractable mechanisms that allow for the tether to be extended and retracted based upon the movement of the child. These devices has proven satisfactory in preventing the child from moving beyond a predetermined distance from the parents. However, as any parent of a young child would attest, children are highly mobile and restrictive mechanisms such as these are undesirable for both the parent and the child in promoting the freedom of the child to move about and play as they naturally tend to do.

Moreover, there are remote alarm systems for vehicles and other personal property that allow the owner of the property to initiate an alarm in response to a perceived threat to the property. However, these devices are bulky and not generally suitable to be portable. In addition, these devices have not seen applications with respect to children due to their size, bulky nature and power requirements.

Therefore, it is an object of the present invention to provide a remote child locator alarm system that could be used to immediately locate the position of a child.

More specifically, it is an object of the present invention to provide a remote child locator alarm utilizing a relatively small compact alarm unit and a relatively small compact remote unit which communicate electronically and wirelessly to provide a remote activated alarm system capable of emitting a significantly loud alarm or other indicia to alert those in the area surrounding the child that the child is lost.

It is another object of the present invention to incorporate a proximity alarm in connection with the remote unit and alarm unit whereby an alarm is emitted when the alarm unit is transported beyond a predetermined distance from the remote unit.

It is a related object of the present invention to incorporate an alarm in connection with the alarm unit that emits a specific audible phrase or term, such as “lost”, “help”, or “stranger”, to specifically communicate to those surrounding the lost child of the specific condition being experienced by the child.

It is another object of the present invention to incorporate specific configurations of the alarm unit that may be securedly attached to the child's garments or person in such a way to present a non-bulky obstacle while also providing a means for deterring would be abductors from removing the alarm unit.

It is also an object of the present invention to incorporate fanciful indicia on the alarm unit, such as a smiling face, cartoon characters or the child's picture, to improve the aesthetic value of the alarm unit and to encourage use by the child.

### SUMMARY OF THE INVENTION

To accomplish these and other related objects of the present invention, the present invention relates to a remote child locator alarm incorporating a remote unit and an alarm unit. The remote unit preferably is a small size capable of being carried in the pocket of the parent of the child. In the preferred embodiment, the remote unit is capable of being attached to a key ring. The remote unit is similar in configuration and size to conventional remote units used for locking an automobile. The remote unit communicates wirelessly to the alarm unit, preferably via infrared means. The alarm unit is a relatively small device capable of being attached to the child's garments or person. The specific configuration of the alarm unit varies depending on the circumstances and the desired application. In the preferred embodiment, the alarm unit is a compact enclosure capable of being attached to the child's belt loop, wrist or shoe by a clasp mechanism. The remote unit is equipped with means for communicating with the alarm unit to initiate an alarm sequence which emits a loud audible sound or words upon initiation of the sequence by the remote unit. In addition, the remote unit and alarm unit may be equipped with a proximity alarm which will allow the alarm and/or the remote unit to emit the loud sound or words when the alarm unit is transported beyond a predetermined distance from the remote unit.

### DESCRIPTION OF THE DRAWINGS

The enclosed drawings represent various configurations of the remote unit and the alarm unit. They include representative configurations of the alarm unit and representative configurations of how the alarm unit may be attached to the garments or person of the child. It is to be understood that these drawings are merely representative of the many configurations possible for the alarm unit and should not be construed in a limiting sense.

FIG. 1. is a representative illustration of one embodiment of the present invention wherein the remote unit is utilized to sound an alarm on the alarm unit, which is shown attached to the wrist of a child.

FIG. 2 is a representative illustration of another embodiment of the present invention that incorporates a proximity alert, which sounds an alarm in the remote unit and the alarm unit when the child exceeds a predetermined distance from the remote unit.

### DESCRIPTION OF THE PREFERRED EMBODIMENT

The following is a description of the preferred embodiment of the present invention. The following embodiment should not be construed as limiting the specified applications for the invention.

The present invention comprises a remote unit 10 and an alarm unit 12. The remote unit and the alarm unit communicate via wireless means and, preferably, via any infrared means well-known in the art. In addition, in an alternative embodiment, the remote unit and alarm unit are equipped with a proximity sensor.

The remote unit 10 of the present invention is conventional and well-known to those in the art. It comprises a relatively small housing 14 generally capable of being carried in the pocket 16 of the user. The exact configuration of the housing 14 may vary depending upon the circumstances and applications at issue but generally is configured to fit within the palm of the hand 18 of the user. In the preferred application, the remote unit is capable of being attached to the key ring.

The remote unit 10 includes means for communicating with the alarm unit 12 and a power source. In the preferred embodiment, the power source is a battery, but may also include other power sources. The means for communicating with the alarm unit 12 are well-known to those in the art and conventional in nature. Examples of a suitable remote unit include a keyless remote unit from the locking system of a Ford Taurus bearing identification numbers FCCIDGQ43VT11T and F87B15K601-BA. A particularly suitable remote unit is found in the luggage locator assembly sold by Luggage Locator, 9200 SW 73rd Street, Miami, Fla. 33156, bearing FCC ID: OMWTL168T. The remote unit 10 is configured to be relatively small in size and capable of being carried comfortably by the user. It is to be understood that other configurations of the remote unit 10 may be employed without departing from the scope of the present invention.

The alarm unit 12 includes a casing 20. The casing 20 may be of any configuration suitable for the application and circumstances and use. A particularly advantageous configuration of the casing 20 would be a relatively small enclosure having at least one generally flat face 22 for displaying indicia. The alarm unit 12 casing 20 contains means for communicating with the remote unit 10, an alarm means and a power source as a battery. The means for communicating with the remote unit 10 is a wireless mechanism of a conventional and well-known nature capable of receiving input from the remote unit 10. Preferably, the mechanism communicates via infrared means of a nature well-known in the art. The communicating means of the alarm unit 12 is coupled with the alarm means. The alarm means is capable of producing a sound or words in response to the activation by the communicating means of the alarm unit 12 when indicia is received from the remote unit 10. The alarm means maybe of a conventional and well-known mechanism well-known to those of ordinary skill in the art.

While infrared communication means are preferred, it is to be understood that other communication means can be employed in connection with the present invention without departing from its scope. For example, the communication means of the alarm unit 12 and remote unit 10 may be an analog or digital communication means such as those used in connection with cellular phones. In addition, the alarm unit 12 can be equipped with a unique marker that can be employed with a global positioning system so that the location of the alarm unit 12 by the remote unit 10 can be detected via satellite. In such application, the remote unit 10 would be equipped with a global positioning satellite mechanism. Such a global positioning system technology is well-known in the art and can be employed in connection with the present invention without undue experimentation. These and other related communication means are within the scope of the present invention.

The specific alarm emitted by the alarm means varies depending upon the circumstances. In the ordinary sense, the alarm can emit a loud noise capable of drawing attention to the child from surrounding individuals. In addition, the alarm should be sufficiently loud to be heard by the parents within a reasonable distance, such as 100 to 200 feet. It is to be understood that a louder alarm may be employed and may provide additional benefits as being uncomfortable to a would-be abductor or being capable of being heard over the loud drone of the shopping mall or sporting event. In the preferred embodiment, the alarm means emits a loud alarm. The alarm should be sufficiently loud to be slightly uncomfortable to the child but not so loud as to present a risk for hearing damage to the child.

In an alternative embodiment, the alarm can be equipped to emit specified words or phrases depending upon the circumstances. The alarm can emit words such as “help”, “lost”, “stranger”, or other suitable phrases and words. In one application, the remote may be equipped with multiple buttons each of which would produce a different word, phrase or alarm depending upon the circumstances perceived by the child's parent. It is to be understood that multiple words and phrases can be employed and the units may be programmed to employ a virtually unlimited combination of words and phrases depending upon the preference of the user. These applications are within the scope of the present invention.

In an alternative embodiment, the remote unit 10 and alarm unit 12 are equipped with a proximity detector. Proximity detectors are well-known in the art and are used for a variety of applications. The proximity alert of the present invention can be any of these conventional and well-known proximity detectors. In this embodiment, a separate alarm means preferably would be incorporated into the remote unit 10. Here, the remote unit 10 is equipped with a range selection control which allows the user to set the desired distance beyond which the alarm means and alarm unit 12 would sound. The parent of the child would be allowed to preselect the distance at which they are most comfortable. In circumstances with a perceived higher risk of abduction or other threat to the child, the parent can reduce the range so that the alarm means would sound at a closer distance from the child. The same alarm selection may be employed and the same purposes may be achieved utilizing the above description of the remote unit 10 and alarm unit 12. The proximity alert embodiment of the present invention is particularly advantageous in instances where the parent is distracted or otherwise unaware that the child has become missing. The proximity alert would sound an alarm in the remote unit 10 and the alarm unit 12 irrespective of the parent's attention to the position of the child. This would be particularly advantageous benefit to reduce the possibility of abduction of the child.

There are numerous acceptable alarm units 12 available on the market. Alarm units 12 of the nature described herein are conventional and well known to those in the art. A particularly advantageous alarm unit 12 is found in the luggage locator assembly sold by Luggage Locator, 9200 SW 73rd Street, Miami, Fla. 33156, bearing FCC ID: OMWTL168T. It is to be understood that other specific configurations and models of alarm unit 12 may be employed with the present invention without departing from its scope.

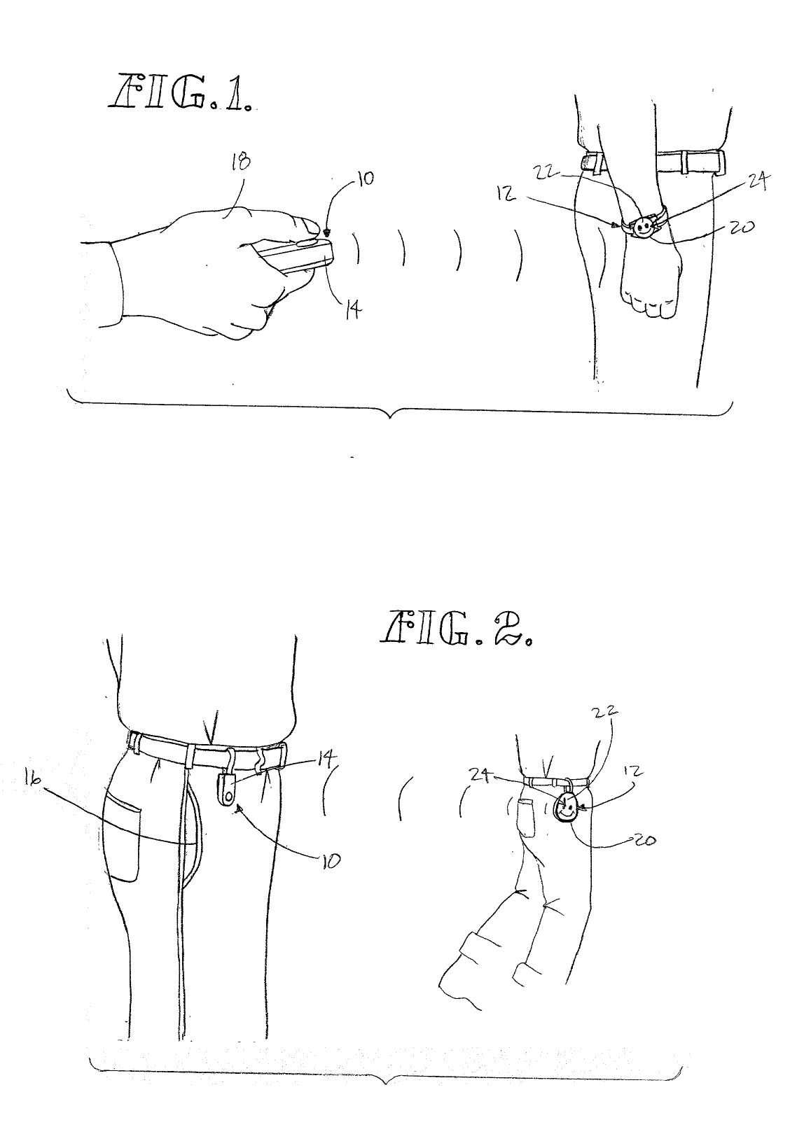

The alarm unit 12 may be attached to the child's garment or person in any number of mechanisms. For example, the alarm unit 12 may be attached via a buckle, clasp, hasp, cable, lock or other means readily known to those skilled in the art for securedly but releasably attaching devices. One particularly advantageous mechanism for attaching the alarm unit 12 to the child is a self-locking clasp wherein a catch-lip is biased into a locking position. The biasing means is sufficiently strong to prevent the removal of the device by the child but weak enough to allow the parent to release the clasp. In the preferred embodiment, the alarm unit 12 would be equipped with means for sensing the removal of the clasp from the child and sounding the alarm means in response to such removal. The alarm unit 12 may be attached to the belt, belt loop, wrist, ankle, zipper, shoe or other article of clothing of the child. As shown in FIG. 1, the alarm unit preferably is attached to the wrist of a child. In FIG. 2, the alarm unit 12 is attached to a belt loop of a child's pants. The location of the attachment of the alarm unit 12 to the child may be varied depending upon the circumstances involved and is within the scope of the present invention.

In the preferred embodiment, the alarm unit 12 is equipped with indicia 24 on at least one flat surface 22 of the alarm unit 12. The indicia 24 may be a fanciful figure such as a cartoon character, which would promote the use of the unit by the child. Alternatively, the indicia 24 may be a photograph and identification information for the child. Also, the indicia 24 may take the form of a warning to would describing the nature of the device and the risk of removing the device from the child. Other indicia 24 may be employed on the alarm unit 12 without departing from the scope of the present invention.

In addition, the alarm unit 12 may be equipped with a volume control which would allow the device to be turned to a louder volume beyond the baseline volume in desired applications. It should be understood that this alarm volume control may also be mounted on the remote unit 10 to prevent manipulation by the child. The volume control means of the present invention is well-known and conventional to those in the art.

It is to be understood that variations of the present invention are contemplated and within the scope of the present invention. For example, the remote unit 10 and alarm unit 12 may be equipped with or without a proximity detector. Conversely, the remote unit 10 and alarm unit 12 may be equipped only with a proximity detector and not with the user-initiated alarm mechanism. These and other variations are within the scope of the present invention.

In use, the parent of the child securedly attaches the alarm unit 12 to the child's clothing or the child's person. The parent of the child ensures that the alarm unit 12 has been securedly attached and that the removal alarm mechanism of the alarm unit 12 is activated. The parent then ensures that he or she has the remote unit 10 available. The parent sets the desired distance for the proximity detector, if it is employed in the embodiment, and the volume of the alarm on the alarm unit 12, if such a volume control is employed in the embodiment.

If at any time the child becomes lost or unable to be located by the parent, the parent may depress the locator button which would communicate via wireless means, such as infrared means, with the alarm unit 12 to initiate the alarm. The alarm may either be a loud alarm sound or specific words or phrases depending upon the application. The parent may select the specific alarm to be sounded via the remote unit 10. Once the child is found, the parent may terminate the alarm by pressing a suitable control button the remote unit 10.

In the event where a proximity detector is employed, the alarm would not sound unless and until the child transported the unit beyond the distance specified with the remote unit 10. Once again, once the child is located, the parent may terminate the alarm be depressing the appropriate control button on the remote unit 10.

Whether a proximity detector is employed or not, the present invention provides an excellent means for parents to locate missing children. The present invention does not employ tethers or other external restraints to prevent the child from moving freely. Similarly, the device of the present invention is transportable and would not interfere with the day-to-day activities of the child. In its preferred embodiment, both the remote unit 10 and alarm unit 12 go unnoticed by both the parent and the child until they are needed. At such time as they are needed, the alarm unit 12 notifies the parent of the location of the child and deters others from harming or abducting the child. The device of the present invention promotes free movement and unhindered fun by a child while giving parents peace of mind that their child is safe and can be located quickly if the need arises.

It is apparent from the foregoing that this invention is well-adapted to attain all the ends and objectives set forth above along with other advantages which are obvious to the invention.

It is to be understood that certain features and subcombinations are useful and may be employed without reference to other features and subcombinations. This is contemplated by the disclosure and is within the scope of the claims.

Because may possible embodiments may be made by the present invention without departing from its scope, it is further understood that all matters set forth herein are to be interpreted as illustrative only and not in the limited sense.

The following is claimed:

1. A child locator device comprising:
a remote unit having a controller coupled with a wireless communicating means;
an alarm unit having receiving means for communicating with the communicating means and being coupled with an alarm means; the alarm unit being adapted to be securedly attached to a child; and
whereby, upon activation of the controller, the communicating means transmits a signal to the receiving means for activation of the alarm means to emit an alarm thereby allowing the child to be located.

2. The child locator device of claim 1 further comprising global positioning means.

3. The child locator device of claim 2 further comprising a proximity detector means.

4. A child locator device comprising:
a remote unit having a proximity detector receiving means and a first alarm means; and
an alarm unit having a proximity detector transmitting means and a second alarm means, the proximity detector transmitting means being capable of communicating with the proximity detector receiving means;
whereby, in the event the alarm unit exceeds a predetermined distance from the remote unit, the proximity detector transmitting means will activate the first and second alarm means to emit an alarm from at least one of said means.

5. The child locator device of claim 4 further comprising a distance control means associated with the remote unit to select the predetermined distance.
